(19) United States
(12) Patent Application Publication
(10) Pub. No.: US 2016/0246740 A1
(43) Pub. Date: Aug. 25, 2016

(54) PROCESSOR SYSTEM HAVING NESTED VECTORED INTERRUPT CONTROLLER

(71) Applicant: Advanced Digital Chips Inc., Gyeonggi-do (KR)

(72) Inventors: Young Ho Cha, Gyeonggi-do (KR); Sang Wan Kim, Gyeonggi-do (KR); Kwan Young Kim, Gyeonggi-do (KR); Byung Gueon Min, Gyeonggi-do (KR)

(21) Appl. No.: 14/664,244

(22) Filed: Mar. 20, 2015

(30) Foreign Application Priority Data
Feb. 23, 2015 (KR) 10-2015-0025062

(51) Int. Cl. G06F 13/24; G06F 9/30

(52) U.S. Cl. CPC G06F 13/24; G06F 9/30098

(57) ABSTRACT

Provided is a processor system including: an integer core which reads and processes instructions transmitted from a lower level unit through an external bus and performs an ISR (Interrupt Service Routine) if an interrupt occurs during a process; a data memory which is directly connected to the integer core through no external bus and stores a GPR (General Purpose Register) and an SPR (Special Purpose Register); and a nested vectored interrupt controller (NVIC) which is directly connected to the integer core and the data memory through no external bus, performs backup of the GPR and SPR from the integer core if an interrupt occurs during the process, and controls an interrupt operation in a manner that the backup GPR and SPR are transmitted to the data memory. Since the processor system has a structure where the nested vectored interrupt controller and the data memory are directly connected to the integer core, operations necessary during an interrupt process, that is, operations of push of GPR and push of SPR and operations of pop of GPR and pop of SPR are speedily performed, so that it is possible to improve an interrupt process rate.

### CROSS-REFERENCE TO RELATED PATENT APPLICATION

This application claims the benefit of Korean Patent Application No. 10-2015-0025062, filed on Feb. 23, 2015 in the Korean Intellectual Property Office, the disclosure of which is incorporated herein in its entirety by reference.

### BACKGROUND OF THE INVENTION

1. Field of the Invention

The present invention relates to a processor system, and more particularly, to a processor system which is effective to a real-time interrupt process.

2. Description of the Related Art

When an instruction set is executed in a computer, a processor is frequently interrupted. The interruption may be caused by an interrupt or an exception.

The interrupt is an asynchronous interrupt event which is not associated with the instruction which is being executed when the interrupt occurs. Namely, the interrupt is caused by some events outside the processor such as input from an input/output device and operation call from another processor. In addition, other interrupts may be caused internally, for example, by expiration of a timer controlling task switching.

The exception is a synchronous event which directly occurs due to the execution of the instruction which is being executed when the exception occurs. Namely, the exception is an event inside the processor such as an arithmetic overflow, a timed maintenance check, an internal performance monitor, and an on-board workload manager. Typically, the exceptions occur more frequently than the interrupts.

As software and hardware of a computer are more complicated, the number and frequency of interrupts are greatly increased. These interrupts are necessary since the interrupts support execution of multiple processes, operation of multiple peripheral devices, and monitoring of performances of various components. Although these features are advantageous, the interrupts cause a large increase in power consumption of a computer to a degree of exceeding the improvement of a process rate of a processor. Therefore, in many cases, although a clock frequency of the processor is increased, system performance may be deteriorated actually.

A processor system requiring a real-time response requires the followings in order to efficiently perform an interrupt process within a short time.

Firstly, an interrupt startup time needs to be minimized. Namely, push of GPR (General Purpose Register) and push of SPR (Special Purpose Register) need to be speedily processed. The performance of this minimization can be improved according to a hardware implementation method.

Secondly, an interrupt process time needs to be minimized. Since this minimization depends on user's program, there is no particular method of improving the performance thereof in terms of hardware.

Thirdly, a time of recovering from the interrupt needs to be minimized. Namely, pop of GPR and pop of SPR need to be speedily processed. The performance of this minimization can be improved according to a hardware implementation method.

As cited literatures, there is Korean Patent Application Laid-Open No. 10-1999-0046284.

### SUMMARY OF THE INVENTION

The present invention is to provide a processor system requiring a real-time response and having a structure capable of efficiently performing an interrupt process within a short time.

The object of the present invention is not limited to the above-mentioned one, and other objects can be clearly understood from the following description by the ordinarily skilled in the art.

According to an aspect of the present invention, there is provided a processor system including: an integer core which reads and processes instructions transmitted from a lower level unit through an external bus and performs an ISR (Interrupt Service Routine) if an interrupt occurs during a process; a data memory which is directly connected to the integer core through no external bus and stores a GPR (General Purpose Register) and an SPR (Special Purpose Register); and a nested vectored interrupt controller (NVIC) which is directly connected to the integer core and the data memory through no external bus, performs backup of the GPR and SPR from the integer core if an interrupt occurs during the process, and controls an interrupt operation in a manner that the backup GPR and SPR are transmitted to the data memory.

In the above aspect, the nested vectored interrupt controller may include: a GPR backup register which is a register for performing backup of the GPR from the integer core; an SPR backup register which is a register for performing backup of the SPR from the integer core; a write buffer which simultaneously receives the GPR and SPR stored in the GPR backup register and the SPR backup register and sequentially transmits the GPR and SPR to the data memory; and a read buffer which sequentially reads the GPR and SPR stored in the data memory and simultaneously stores the read GPR and SPR in the GPR backup register or the SPR backup register.

In addition, if an interrupt process request is applied during the process, the integer core may perform an operation of push of GPR and SPR to store the GPR and SPR which is being used during the process through the nested vectored interrupt controller in the data memory and perform the ISR for an interrupt process, and if the ISR is ended, the integer core may perform an operation of pop of GPR and SPR and recover the GPR and SPR stored in the data memory to resume the process.

In addition, during the operation of push of GPR and SPR, the GPR and SPR may be stored in one cycle in the GPR backup register and the SPR backup register of the nested vectored interrupt controller, and during the operation of pop of GPR and SPR, the GPR and SPR may be immediately recovered in one cycle from the GPR backup register and the SPR backup register of the nested vectored interrupt controller.

In addition, in a nested interrupt case where, when a first ISR is being processed due to occurrence of an interrupt during a process in the integer core, a new interrupt having a higher priority order occurs, so that a second ISR is processed with priority, and after the second ISR is processed, the first ISR is processed, and a procedure returns to the process, in order to perform the first ISR, during operation of push of GPR and SPR, the GPR and SPR are immediately stored in one cycle in the GPR backup register and the SPR backup register of the nested vectored interrupt controller, in order to perform the second ISR, during operation of push of GPR′ and SPR′, the GPR and SPR stored in the GPR backup register and the SPR backup register are transmitted to the write buffer, and at the same time, the GPR′ and SPR′ are immediately stored in one cycle in the GPR backup register and the SPR backup register, the GPR and SPR stored in the write buffer are stored in n cycles in the data memory, and the performing of the second ISR is ended, in order to return to the first ISR, during operation of pop of GPR′ and SPR′, the GPR′ and SPR′ stored in the GPR backup register and the SPR backup register are recovered in one cycle, and at the same time, the GPR and SPR stored in the data memory are stored through the read buffer in the GPR backup register and the SPR backup register, and the performing of the first ISR is ended, and in order to return to the process, during operation of pop of GPR and SPR, the GPR and SPR stored in the GPR backup register and the SPR backup register are recovered in one cycle.

According to the present invention, a processor system has a structure where a nested vectored interrupt controller and a data memory are directly connected to an integer core, and thus, operations necessary during an interrupt process, that is, operations of push of GPR and push of SPR and operations of pop of GPR and pop of SPR are speedily performed, so that it is possible to improve an interrupt process rate.

### BRIEF DESCRIPTION OF THE DRAWINGS

The above and other features and advantages of the present invention will become more apparent by describing in detail exemplary embodiments thereof with reference to the attached drawings in which:

FIG. 1 is a flowchart illustrating an interrupt process procedure;

FIG. 2 is a table listing values of SPR and GPR of FIG. 1;

FIG. 3 is a table listing value of SPR′ and GPR′ of FIG. 1;

FIGS. 4A to 4C are conceptual diagrams illustrating an example of an interrupt processing method;

FIGS. 5 and 6 are block diagrams illustrating a configuration of a processor system including a nested vectored interrupt controller (NVIC);

FIG. 7 is a block diagram illustrating a configuration of a processor system including a nested vectored interrupt controller according to an embodiment of the present invention;

FIG. 8 is a block diagram illustrating an internal configuration of a nested vectored interrupt controller of the processor system according to the embodiment of the present invention; and

FIG. 9 is a table listing positions where GPR, SPR, GPR′, and SPR′ are stored in the processor system according to the embodiment of the present invention.

### DETAILED DESCRIPTION OF THE PREFERRED EMBODIMENTS

The present invention can be implemented with various changes and embodiments. Hereinafter, specific embodiments will be described in detail with reference to the drawings. However, it is not intended that the invention is limited to the specific embodiments, and it should be noted that all changes, equivalents, and alternatives within the spirit and scope of the invention are included in the invention.

Terms used in the application are used for explaining only specific embodiments, which is not intended to limit the present invention. Singular expression includes plural expression if it does not have explicitly different meanings in context. It should be noted that the term “to include” or “to have” in the application is intended to indicate the existence of features, numbers, steps, operations, components, parts, or a combination thereof disclosed in the specification but not excludes the existence or possibility of addition of one or more different features, numbers, steps, operations, parts, or a combination thereof in advance.

If not differently defined, all terms including technical or scientific terms used herein have the same meanings as generally comprehended by the ordinarily skilled in the related art.

Terms such as terms generally used and defined in a dictionary should be analyzed to have meanings in accordance with the meanings in contexts of related techniques, and unless the terms are not explicitly defined in the application, the terms should not be analyzed with ideal or excessively formalized meanings.

In addition, the same components are denoted by the same reference numerals, and the redundant description thereof will be omitted. Detailed descriptions of well-known techniques may be omitted so as not to unnecessarily obscure the invention.

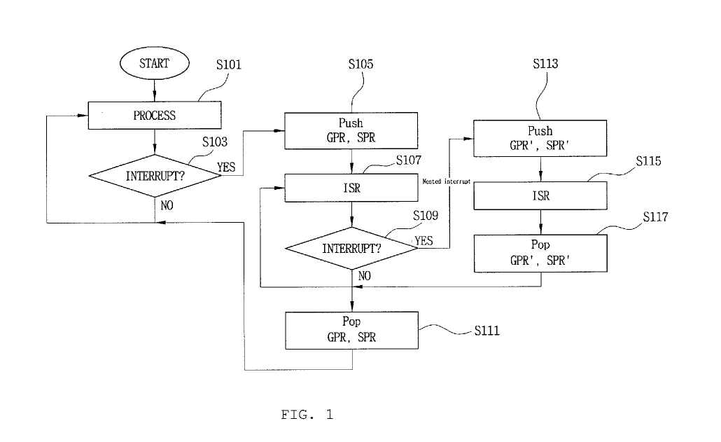

FIG. 1 is a flowchart illustrating an interrupt process procedure.

Referring to FIG. 1, during a process, that is, during program operation (S101), if an interrupt occurs (S103), push of GPR (General Purpose Register) and SPR (Special Purpose Register) for storing the GPR and the SPR which are used during the process is performed (S105).

Next, an ISR (Interrupt Service Routine) operation for the interrupt process is performed (S107).

Next, if the ISR operation is ended, pop of GPR and SPR which is an operation for recovering the values stored in the push of GPR and SPR again is performed (S111).

If an interrupt occurs during the ISR operation (S109), push of GPR′ and SPR′ for storing the GPR′ and the SPR′ which are used during the ISR operation is performed (S113). The case where interrupt occurs during the ISR operation is called nested interrupt.

After step S113, the ISR operation is performed (S115). If the ISR operation is ended, pop of GPR′ and SPR′ which is an operation for recovering the values stored in the push of GPR′ and SPR′ again is performed (S117). Herein, GPR′ and SPR′ are expression for distinguishing from the GPR and GPR stored in the case where interrupt occurs in the process state.

Since the GPR and SPR and the GPR′ and SPR′ use physically the same area, backup to a stack memory is necessary.

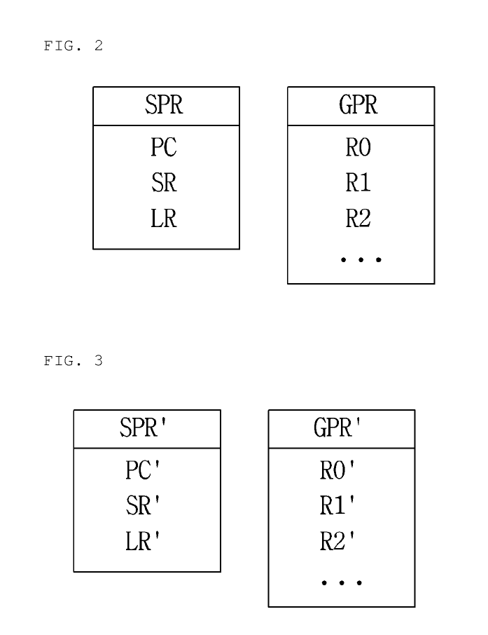

FIG. 2 is a table listing values of the SPR and GPR of FIG. 1, and FIG. 3 is a table listing values of the SPR′ and GPR′ of FIG. 1.

In FIGS. 2 and 3, PC (Program Counter), SR (Status Register), and LR (Linked Register) are stored in the SPR, and R0, R1, R2, and the like are stored in the GPR.

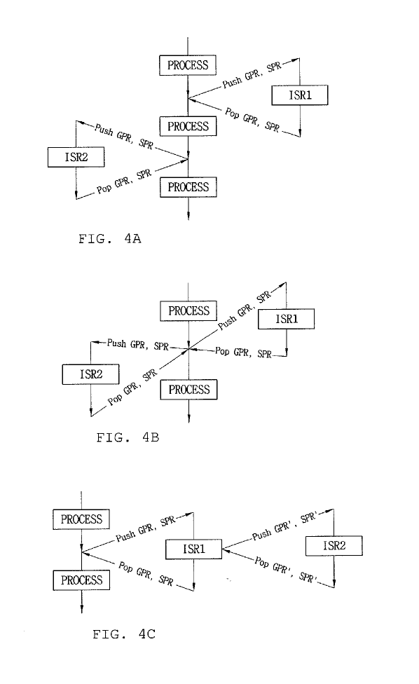

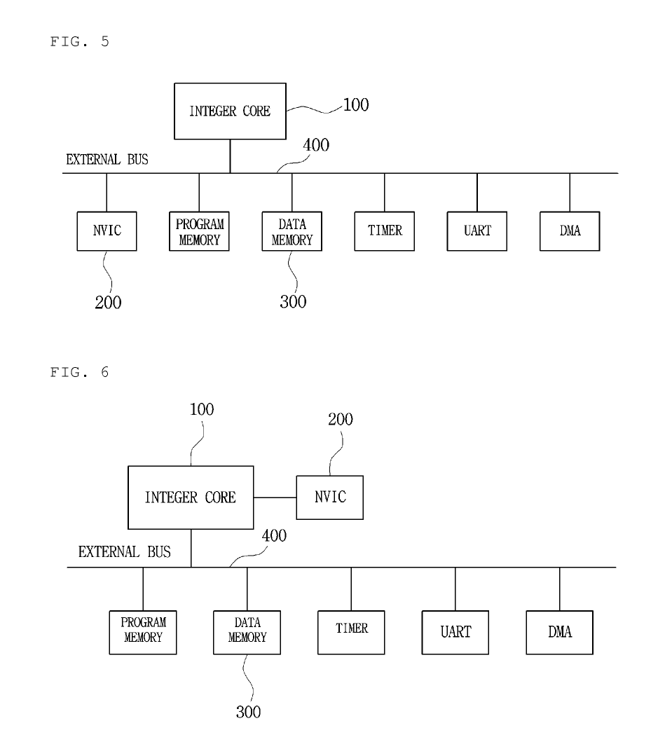

FIGS. 4A to 4C are conceptual diagrams illustrating an example of an interrupt processing method.

FIG. 4A illustrates a case of processing interrupts which sequentially occur, FIG. 4B illustrates a case of processing interrupts which continuously occur, and FIG. 4C illustrate a case of processing interrupts (nested interrupts) which overlappedly occur.

If an interrupt occurs, the GPR and SPR which are being used during the process are stored in a data memory or a stack memory, and after the interrupt is processed (ISR), the stored GPR and SPR are recovered, and the operation which are previously being processed during the process is resumed.

FIG. 4A is a case where one interrupt simultaneously occurs.

In FIG. 4A, after the interrupt occurs and a process on an ISR1 is completed, an interrupt occurs so that a process on an ISR2 is performed.

FIG. 4B is a case where two or more interrupts simultaneously occur and are sequentially processed according to a priority order or a case where a new interrupt occurs during a process of one interrupt and, after the process of one interrupt is completed, the new interrupt is processed.

FIG. 4B is a case where, due to occurrence of an interrupt during a process, an ISR1 is processed, and in the meantime, a new interrupt occurs, after the ISR1 having a higher priority order is processed, an ISR2 is processed.

FIG. 4C is a case where a new interrupt occurs during a process of an interrupt and the new interrupt is processed. The interrupt of this case is called a nested interrupt.

In FIG. 4C, in the case of processing the nested interrupt, after the GPR′ and SPR′ which are being processed in the ISR1 are stored in the data memory, the nested interrupt is processed (ISR2), and after that, the stored GPR′ and SPR′ are recovered, and the existing interrupt is processed (ISR1).

Namely, FIG. 4C is a case where, due to occurrence of an interrupt during a process, an ISR1 is processed, and in the meantime, a new interrupt having a higher priority order occurs, and after the ISR2 is processed with priority, the ISR1 is processed, and the procedure to the process.

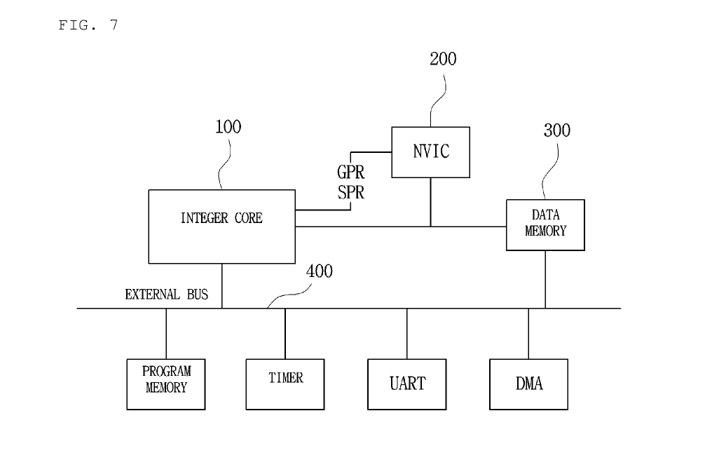

FIGS. 5 and 6 are block diagrams illustrating a configuration of a process system including a nested vectored interrupt controller (NVIC).

Referring to FIGS. 5 and 6, the processor system is configured to include an integer core 100, a nested vectored interrupt controller (NVIC) 200, and a data memory 300.

FIG. 5 illustrates an example of a configuration of the processor system where the nested vectored interrupt controller 200 and the data memory 300 are connected to an external bus 400.

In FIG. 5, since the external bus 400 needs to be used in order to transmit values of the GPR and SPR between the integer core 100 and the data memory 300, n cycles are necessary.

Namely, data (GPR and SPR) between the data memory 300 and the integer core 100 need to be transmitted through the external bus 400.

However, since a program memory, a timer, a UART (Universal Asynchronous Receiver/Transmitter), a DMA (Direct memory access), and the like are used in the external bus 400, the data memory 300 exclusively uses the external bus 400, and thus, the integer core 100 and the data memory 300 cannot be connected at a speed of 1 cycle. As a result, n cycles are necessary, and deterioration in speed occurs.

FIG. 6 illustrates an example of a configuration of a processor system where the nested vectored interrupt controller 200 and the integer core 100 are directly connected to each other and the data memory 300 is connected to the external bus 400.

In FIG. 6, since the external bus 400 needs to be used in order to transmit values of the GPR and SPR between the integer core 100 and the data memory 300, n cycles are necessary.

FIG. 7 is a block diagram illustrating a configuration of a processor system including a nested vectored interrupt controller according to the embodiment of the present invention.

Referring to FIG. 7, the processor system according to the embodiment of the present invention is configured to include an integer core 100, a nested vectored interrupt controller (NVIC) 200, a data memory 300, and an external bus 400.

In FIG. 7, the processor system has a configuration where the nested vectored interrupt controller 200 and the data memory 300 are directly connected to the integer core 100 and the nested vectored interrupt controller 200 and the data memory 300 are directly connected to each other.

The integer core 100 reads and processes instructions transmitted from lower level units (program memory, timer, UART, DMA, and the like) through the external bus, and if an interrupt occurs during the process, the integer core performs an ISR (Interrupt Service Routine).

The data memory 300 is directly connected to the integer core 100 through no external bus and has a function of storing the GPR and the SPR.

The nested vectored interrupt controller 200 are directly connected to the integer core 100 and the data memory 300 through no external bus, and if an interrupt occurs during the process, the nested vectored interrupt controller performs backup of the GPR and SPR from the integer core 100 and controls the interrupt operation in a manner that the backup GPR and SPR are transmitted to the data memory 300.

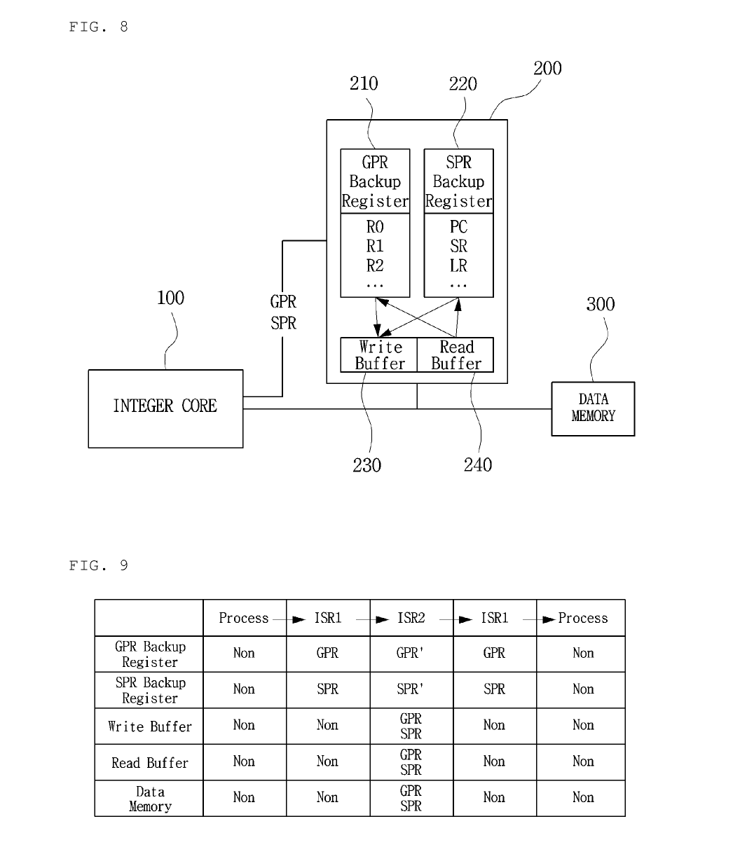

FIG. 8 is a block diagram illustrating an internal configuration of a nested vectored interrupt controller of the processor system according to the embodiment of the present invention.

Referring to FIG. 8, the nested vectored interrupt controller 200 of the processor system according to the embodiment of the present invention is configured to include a GPR backup register 210, an SPR backup register 220, a write buffer 230, and a read buffer 240.

The GPR backup register 210 has a function of performing backup of the GPR from the integer core 100.

The SPR backup register 220 has a function of performing backup of the SPR from the integer core 100.

The write buffer 230 has a function of simultaneously receiving the GPR and SPR stored in the GPR and SPR backup registers 210 and 220 and sequentially transmitting the GPR and SPR to the data memory 300.

The read buffer 240 has a function of sequentially reading the GPR and SPR stored in the data memory 300 and simultaneously stored in the read GPR and SPR in the GPR backup register 210 or the SPR backup register 220.

In the present invention, if an interrupt process request is applied during a process, the integer core 100 performs an operation of push of GPR and SPR to store the GPR and SPR which are being used during the process in the data memory 300 through the nested vectored interrupt controller 200 and performs the ISR for the interrupt process. If the ISR is ended, the integer core performs an operation of pop of GPR and SPR to recover the GPR and SPR stored in the data memory 300 and resumes the process.

Even through a data width is large, the power consumption of the registers 210 and 220 is not increased, and thus, the registers are connected in parallel so as to perform direct backup of the GPR and SPR inside the integer core 100.

On the other hand, since the data memory 300 is generally configured with an SRAM, if the data width is increased, the power consumption of the data memory is also increased. Therefore, the data memory 300 is generally configured to have a minimum data width in order to reduce power consumption. For example, the data memory may be configured with a 32-bit data width.

If the GPR′ and SPR′ are received in the state where the GPR and SPR are stored in the backup register 210 and 220, the GPR and SPR which are stored are simultaneously transmitted to the write buffer 230.

Next, the write buffer 230 sequentially stores the GPR and SPR one by one in the data memory 300.

Next, when the GPR and SPR or the GPR′ and SPR′ stored in the data memory 300 are received, the data are sequentially read through the read buffer 240, and after that, the data are simultaneously stored in the backup registers 210 and 220.

In the case of FIG. 4A, the operations of the processor system including the nested vectored interrupt controller according to the present invention is described as follows.

In FIG. 4A, during the operation of push of GPR and SPR, the GPR and SPR can be immediately stored in one cycle in the GPR backup register 210 and the SPR backup register 220 of the nested vectored interrupt controller 200.

In addition, during the operation of pop of GPR and SPR, the GPR and SPR can be immediately recovered in one cycle from the GPR backup register 210 and the SPR backup register 220 of the nested vectored interrupt controller 200.

As a reference, in an existing structure, in order to perform the ISR1, during the operation of push of GPR and SPR, the data corresponding to the number of GPRs and the number of SPRs are sequentially stored in n cycles in the data memory 300; and in order to return to the process, during the operation of pop of GPR and SPR, the data corresponding to the number of GPRs and the number of SPRs are sequentially recovered in n cycles from the data memory 300.

Next, in the case of FIG. 4B, the operations of the processor system including the nested vectored interrupt controller according to the present invention is described as follows.

In FIG. 4B, during the operation of push of GPR and SPR, the GPR and SPR can be immediately stored in one cycle in the GPR backup register 210 and the SPR backup register 220 of the nested vectored interrupt controller 200.

In addition, during the operation of pop of GPR and SPR, the GPR and SPR can be immediately recovered in one cycle from the GPR backup register 210 and the SPR backup register 220 of the nested vectored interrupt controller 200.

As a reference, in the existing structure, in order to perform the ISR1, during the operation of push of GPR and SPR, the data corresponding to the number of GPRs and the number of SPRs are sequentially stored in n cycles in the data memory 300; and in order to return to the process, during the operation of pop of GPR and SPR, the data corresponding to the number of GPRs and the number of SPRs are sequentially in n cycles from the data memory 300.

Next, in the existing structure, in order to perform the ISR2, during the operation of push of GPR and SPR, the data corresponding to the number of GPRs and the number of SPRs are sequentially in n cycles in the data memory 300; and in order to return to the process, during the operation of pop of GPR and SPR, the data corresponding to the number of GPRs and the number of SPRs are sequentially recovered in n cycles from the data memory 300.

Next, in the case of FIG. 4C, the operations of the processor system including the nested vectored interrupt controller according to the present invention is described as follows.

In the case of FIG. 4C, the positions where the GPR, SPR, GPR′, and SPR′ are stored are collectively listed in a table of FIG. 9.

FIG. 9 is a table listing positions where the GPR, SPR, GPR′, and SPR′ are stored in the processor system according to the embodiment of the present invention.

FIG. 4C is a nested interrupt case where, when the ISR1 is being processed due to occurrence of an interrupt during the process in the integer core 100, a new interrupt having a higher priority order occurs, so that the ISR2 is processed with priority, and after the ISR2 is processed, the ISR1 is processed, and the procedure returns to the process.

In FIG. 4C, in order to perform the ISR1, during the operation of push of GPR and SPR, the GPR and SPR are immediately stored in one cycle in the GPR backup register 210 and the SPR backup register 220 of the nested vectored interrupt controller 200.

Next, in order to perform the ISR2, during the operation of push of GPR′ and SPR′, the GPR and SPR stored in the GPR backup register 210 and the SPR backup register 220 are transmitted through the write buffer 230, and at the same time, the GPR′ and SPR′ can be immediately stored in one cycle in the GPR backup register 210 and the SPR backup register 220.

Next, the GPR and SPR stored in the write buffer 230 are stored in n cycles in the data memory, and the performing of the ISR2 is ended.

In order to return to the ISR1, during the operation of pop of GPR′ and SPR′, the GPR′ and SPR′ stored in the GPR backup register 210 and the SPR backup register 220 are recovered in one cycle, and at the same time, the GPR and SPR stored in the data memory 300 are stored through the read buffer 240 in the GPR backup register 210 and the SPR backup register 220, and the performing of the ISR1 is ended.

Next, in order to return to the process, during the operation of pop of GPR and SPR, the GPR and SPR stored in the GPR backup register 210 and the SPR backup register 220 are recovered in one cycle.

As a reference, in the existing structure, in order to perform the ISR1, during the operation of push of GPR and SPR, the data corresponding to the number of GPRs and the number of SPRs are sequentially stored in n cycles in the data memory 300; and n order to perform the ISR2, during the operation of push of GPR′ and SPR′, the data corresponding to the number of GPR's and the number of SPR's are sequentially stored in n cycles in the data memory 300, and the performing of the ISR2 is ended.

Next, in the existing structure, in order to return to the ISR1, during the operation of pop of GPR′ and SPR′, the data corresponding to the number of GPR's and the number of SPR's are sequentially recovered in n cycles from the data memory 300, and the performing of the ISR1 is ended.

Next, in the existing structure, in order to return to the process, during the operation of pop of GPR and SPR, the data corresponding to the number of GPRs and the number of SPRs are sequentially recovered in n cycles from the data memory 300.

As described above, in the present invention, the operation of push of GPR and SPR and the operation of pop of GPR and SPR which are necessary operations during the interrupt process are performed speedily by using the structure where the nested vectored interrupt controller 200 and the data memory 300 are directly connected to the integer core 100, so that it is possible to improve the speed of the interrupt process in comparison with the existing structure.

While the present invention has been particularly shown and described with reference to exemplary embodiments thereof, it will be understood by those skilled in the art that various changes in form and details may be made therein without departing from the spirit and scope of the present invention as defined by the appended claims.

What is claimed is:

1. A processor system comprising:
an integer core which reads and processes instructions transmitted from a lower level unit through an external bus and performs an ISR (Interrupt Service Routine) if an interrupt occurs during a process;
a data memory which is directly connected to the integer core through no external bus and stores a GPR (General Purpose Register) and an SPR (Special Purpose Register); and
a nested vectored interrupt controller (NVIC) which is directly connected to the integer core and the data memory through no external bus, performs backup of the GPR and SPR from the integer core if an interrupt occurs during the process, and controls an interrupt operation in a manner that the backup GPR and SPR are transmitted to the data memory.

2. The processor system according to claim 1, wherein the nested vectored interrupt controller includes:
a GPR backup register which is a register for performing backup of the GPR from the integer core;
an SPR backup register which is a register for performing backup of the SPR from the integer core;
a write buffer which simultaneously receives the GPR and SPR stored in the GPR backup register and the SPR backup register and sequentially transmits the GPR and SPR to the data memory; and
a read buffer which sequentially reads the GPR and SPR stored in the data memory and simultaneously stores the read GPR and SPR in the GPR backup register or the SPR backup register.

3. The processor system according to claim 2, wherein, if an interrupt process request is applied during the process, the integer core performs an operation of push of GPR and SPR to store the GPR and SPR which is being used during the process through the nested vectored interrupt controller in the data memory and performs the ISR for an interrupt process, and if the ISR is ended, the integer core performs an operation of pop of GPR and SPR and recovers the GPR and SPR stored in the data memory to resume the process.

4. The processor system according to claim 3, wherein, during the operation of push of GPR and SPR, the GPR and SPR are stored in one cycle in the GPR backup register and the SPR backup register of the nested vectored interrupt controller, and during the operation of pop of GPR and SPR, the GPR and SPR are immediately recovered in one cycle from the GPR backup register and the SPR backup register of the nested vectored interrupt controller.

5. The processor system according to claim 3,
wherein in a nested interrupt case where, when a first ISR is being processed due to occurrence of an interrupt during a process in the integer core, a new interrupt having a higher priority order occurs, so that a second ISR is processed with priority, and after the second ISR is processed, the first ISR is processed, and a procedure returns to the process,
in order to perform the first ISR, during operation of push of GPR and SPR, the GPR and SPR are immediately stored in one cycle in the GPR backup register and the SPR backup register of the nested vectored interrupt controller, in order to perform the second ISR, during operation of push of GPR′ and SPR′, the GPR and SPR stored in the GPR backup register and the SPR backup register are transmitted to the write buffer, and at the same time, the GPR′ and SPR′ are immediately stored in one cycle in the GPR backup register and the SPR backup register, the GPR and SPR stored in the write buffer are stored in n cycles in the data memory, and the performing of the second ISR is ended,
in order to return to the first ISR, during operation of pop of GPR′ and SPR′, the GPR′ and SPR′ stored in the GPR backup register and the SPR backup register are recovered in one cycle, and at the same time, the GPR and SPR stored in the data memory are stored through the read buffer in the GPR backup register and the SPR backup register, and the performing of the first ISR is ended, and
in order to return to the process, during operation of pop of GPR and SPR, the GPR and SPR stored in the GPR backup register and the SPR backup register are recovered in one cycle.
